(19) United States
(12) Patent Application Publication
(10) Pub. No.: US 2026/0351488 A1
(43) Pub. Date: Nov. 5, 2026

(54) BINDER-FREE CAPACITOR, METHOD OF MANUFACTURING THE SAME, AND ELECTRODE MODULE OF BINDER-FREE CAPACITOR

(71) Applicant: NANYA TECHNOLOGY CORPORATION, NEW TAIPEI CITY (TW)

(72) Inventor: WEI-CHUAN FANG, NEW TAIPEI CITY (TW)

(21) Appl. No.: 19/198,363

(22) Filed: May 5, 2025

(51) Int. Cl. H01G 11/28; H01G 11/36; H01G 11/86

(52) U.S. Cl. CPC H01G 11/28; H01G 11/36; H01G 11/86

(57) ABSTRACT

The present disclosure provides a capacitor, a method for manufacturing the capacitor, and an electrode module of the capacitor. The capacitor includes a first electrode module, a second electrode module, an electrolyte solution, and a separating film. At least one of the first electrode module and the second electrode module includes a current collector and an active layer. The active layer is immersed in the electrolyte solution. The separating film is disposed between the first electrode module and the second electrode module, and is immersed in the electrolyte solution. The active layer includes a carbon structure layer and a metallic layer attached to the carbon structure layer. The carbon structure layer is deposited on the current collector.

### TECHNICAL FIELD

The present disclosure relates to an electrical storage device, a method of manufacturing the electrical storage device, and an electrode module of the electrical storage device, and more particularly, to a capacitor, a method of manufacturing the capacitor, and an electrode module of the capacitor.

### DISCUSSION OF THE BACKGROUND

Electrostatic double-layer capacitors (EDLCs), commonly referred to as super capacitors, are energy storage devices that bridge the gap between conventional capacitors and rechargeable batteries. Unlike traditional batteries that rely on chemical reactions to store energy, super capacitors store energy electrostatically through the formation of an electric double layer at the interface between the electrode surface and the electrolyte. This unique mechanism allows super capacitors to deliver exceptionally high power density, enabling rapid charging and discharging processes.

Super capacitors have found increasing utilization in various applications where quick bursts of energy and long cycle life are essential. They are often considered as alternatives or complements to lithium-ion batteries, particularly in scenarios requiring fast energy delivery or frequent charge/discharge cycles. For instance, super capacitors are employed in regenerative braking systems in electric vehicles, where they capture and release energy efficiently during acceleration and deceleration. Additionally, they serve as reliable components in uninterruptible power supplies (UPS), providing immediate backup power to critical systems during short power interruptions, thereby enhancing system stability and lifetime.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a capacitor. The capacitor includes a first electrode module, a second electrode module, an electrolyte solution, and a separating film. At least one of the first electrode module and the second electrode module comprises a current collector and an active layer. The active layer is immersed in the electrolyte solution. The separating film is disposed between the first electrode module and the second electrode module, and is immersed in the electrolyte solution. The active layer includes a carbon structure layer and a metallic layer attached to the carbon structure layer. The carbon structure layer is deposited on the current collector.

One aspect of the present disclosure provides a method of manufacturing a capacitor. The method includes: providing a first current collector and a second current collector; forming an active layer on at least one of the first current collector and the second current collector; disposing a separating film between the first current collector and the second current collector; and immersing the separating film and the active layer on the at least one of the first current collector and the second current collector into an electrolyte solution. Forming the active layer includes: depositing a carbon structure layer on the at least one of the first current collector and the second current collector; and forming a metallic layer attached to the carbon structure layer on the at least one of the first current collector and the second current collector.

One aspect of the present disclosure provides an electrode module of an electrostatic double-layer capacitor. The electrode module includes a current collector and an active layer. The active layer includes a carbon structure layer and a metallic layer. The carbon structure layer is deposited on the current collector. The metallic layer is attached to the carbon structure layer. The metallic layer includes metallic nanoparticles, metallic nanofibers, or a combination thereof.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic diagram of a capacitor according to some embodiments of the present disclosure.

FIG. 2 is a perspective view showing an electrode module of FIG. 1, according to some embodiments of the present disclosure.

FIG. 3 is a flowchart of a method for manufacturing the capacitor of FIG. 1, according to some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

In some comparative embodiments of the electrostatic double-layer capacitors (EDLCs), binders are used to bind active materials (e.g., porous carbon material) in the form of powder into mechanically stable and electrically conductive active layers. The binders also facilitate the adhesion of the active layers to the current collector, thereby forming the positive or negative electrode of the EDLC. In one comparative embodiment, the binder may include polytetrafluoroethylene (PTFE). However, the presence of binders increases the overall electrode resistance and reduces the capacitance of the EDLC. In some comparative embodiments, binder-free active layers may be fabricated through a series of complex processes, such as sequentially preparing a solution containing the active materials, vacuum filtration, and annealing. It is noted that these processes are very time-consuming.

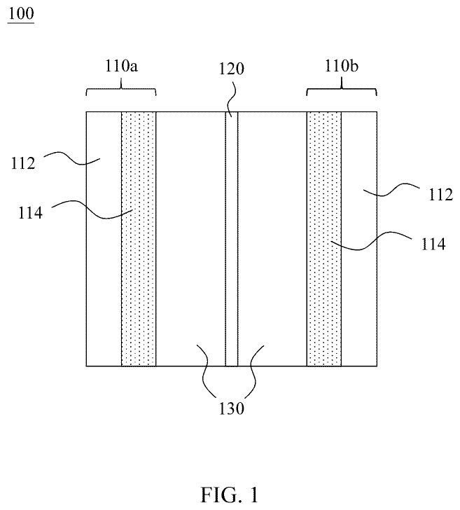

FIG. 1 is a schematic diagram of a capacitor 100 according to some embodiments of the present disclosure. The capacitor 100 includes electrode modules 110a and 110b, separating film 120, and electrolyte solution 130. The electrode modules 110a and 110b are configured to be the positive electrode and the negative electrode of the capacitor 100, respectively. The separating film 120 is ion-permeable; therefore the electrode modules 110a and 110b are electrically connected through the electrolyte solution 130. The separating film 120 functions as an insulator, preventing short circuits between the electrode modules 110a and 110b. In some embodiments, the electrolyte solution may be alkaline solution (e.g., the sodium hydroxide aqueous solution), acid solution (e.g., the sodium sulfate aqueous solution), or organic solution (e.g., the polycarbonate solution). The organic solution usually has a high breakdown voltage, which facilitates for high-voltage applications of the capacitor 100.

At least one of the electrode modules 110a and 110b includes a current collector 112 and an active layer 114. The current collectors 112 are configured to connect the capacitor 100 to an external device (not shown) that charges or discharges the capacitor 100. In some embodiments, the current collectors 112 may be metal foils. In some embodiments, the active layers 114 and the separating film 120 are immersed in the electrolyte solution 130. The active layers 114 include porous materials with high surface areas that increase ion accessibility, thereby increasing the energy stored per unit volume. In some embodiments, the capacitor 100 may be an EDLC.

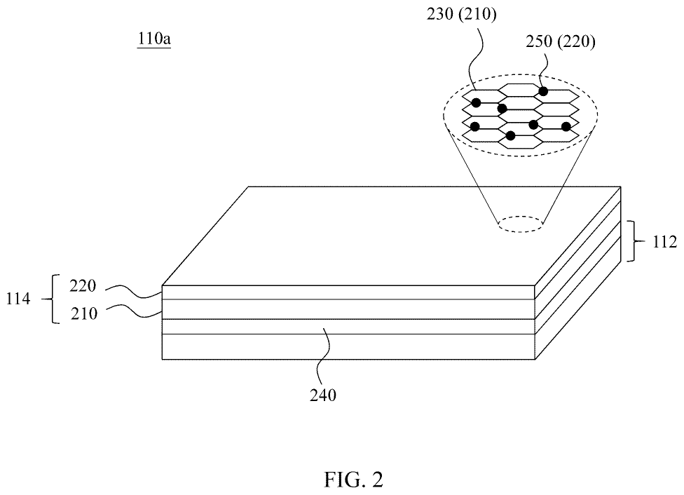

FIG. 2 is a perspective view showing the electrode module 110a of FIG. 1, according to some embodiments of the present disclosure. The structures of the electrode modules 110a and 110b may be similar or identical to each other; and therefore the detailed descriptions of the electrode module 110b are omitted for the sake of brevity. The electrode 110a includes a carbon structure layer 210 and a metallic layer 220. The carbon structure layer 210 is deposited on the current collector 112 by, for example, chemical vapor deposition (CVD). Therefore, a first surface of the carbon structure layer 210 is attached to the current collector 112. The metallic layer 220 is attached to a second surface of the carbon structure layer 210, while the first surface and the second surface of the carbon structure layer 210 are opposite to each other.

In some embodiments, the carbon structure layer 210 includes graphene 230; however, the present disclosure is not limited thereto. In other embodiments, the carbon structure layer 210 includes carbon nanotubes (CNTs) or a combination of the graphene 230 and the CNTs. The current collector 112 may be a silicon substrate. To enhance the adhesion of the carbon structure layer 210 onto the current collector 112, a metal silicide layer 240 may be formed on the surface of the current collector 112, and the carbon structure layer 210 is deposited on the metal silicide layer 240. In some embodiments, the metal silicide layer 240 includes a titanium silicide (e.g., TiSi₂) layer, where the titanium silicide layer may be formed at least by the electroplating process. For example, a titanium film can be electroplated onto the silicon substrate, and then the annealing process is performed to convert the titanium film into the titanium silicide layer. As another example, the metal silicide layer 240 may be formed by vacuum sputtering process.

To enhance the uniformity of the distribution of carbon structure layer 210 on the current collector 112, the carbon structure layer 210 may be doped with nitrogen. A ratio of nitrogen atoms to all atoms of the carbon structure layer 210 is within a range from about 3% to about 10%.

In some embodiments, the metallic layer 220 includes titanium nitride (TiN) nanoparticles 250 deposited on the carbon structure layer 210. The TiN nanoparticles 250 may be formed on the carbon structure layer 210 by physical vapor deposition (PVD), by using the graphene 230 and/or the CMTs as the scaffolds.

In other embodiments, the metallic layer 220 includes TiN nanofibers adhered to the carbon structure layer 210. To form the TiN nanofibers, titanium may be electroplated on the carbon structure layer 210 to form titanium nanofibers, by using the graphene 230 and/or the CMTs as the scaffolds. Then, a nitridation process may be performed to convert the titanium nanofibers to TiN nanofibers. However, the present disclosure is not limited thereto. In some embodiments, the metallic layer 220 includes a combination of the TiN nanoparticles 250 and the TiN nanofibers.

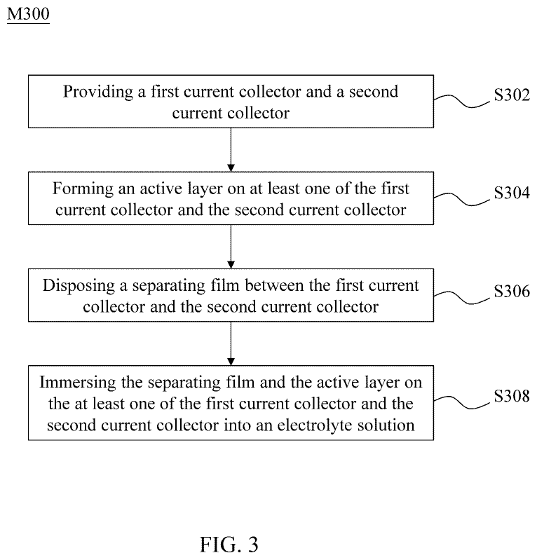

FIG. 3 is a flowchart of a method M300 for manufacturing the capacitor 100 of FIG. 1, according to some embodiments of the present disclosure. The method M300 includes operations S302 to S308. In operation S302, a first current collector and a second current collector are provided. For example, referring to FIG. 1, the current collector 112 of the electrode module 110a and the current collector 112 of the electrode module 110b are provided. In some embodiments, a metal silicide layer may be formed on the surface of at least one of the first current collector and the second current collector at least by the electroplating process, where the metal silicide layer may be the titanium silicide layer.

In operation S304, an active layer on at least one of the first current collector and the second current collector is formed. For example, referring to FIG. 1, the active layer 114 on the current collector 112 of at least one of the electrode modules 110a and 110b is formed. As shown in FIG. 2, the carbon structure layer 210 of the active layer 114 is deposited on the current collector 112. Then, the metallic layer 220 of the active layer 114 is formed, which is attached to the carbon structure layer 210. In some embodiments, the carbon structure layer may be doped with nitrogen. In some embodiments, the metallic layer is formed by depositing TiN nanoparticles on the carbon structure layer. In some embodiments, the metallic layer is formed by the electroplating process and the nitridation process to obtain the TiN nanofibers on the carbon structure layer.

In operation S306, a separating film is disposed between the first current collector and the second current collector. For example, referring to FIG. 1, the separating film 120 is disposed between the current collector 112 of the electrode module 110a and the current collector 112 of the electrode module 110b.

In operation S308, the separating film and the active layer on the at least one of the first current collector and the second current collector are immersed in an electrolyte solution. For example, referring to FIG. 1, the separating film 120 and the active layers 114 on the current collectors 112 are immersed in the electrolyte solution 130.

Accordingly, the capacitors of the present disclosure needs not to rely on the polymer binders. The active layer (e.g., the carbon structure layer and the metallic layer) is free from being bounded by the polymer binders onto the current collector. Therefore, the capacitors of the present disclosure reduce the overall electrode resistance and have greater capacitance. Furthermore, the methods for manufacturing the capacitors of the present disclosure has less steps, facilitating for the improvement of efficiency.

One aspect of the present disclosure provides a capacitor. The capacitor includes a first electrode module, a second electrode module, an electrolyte solution, and a separating film. At least one of the first electrode module and the second electrode module comprises a current collector and an active layer. The active layer is immersed in the electrolyte solution. The separating film is disposed between the first electrode module and the second electrode module, and is immersed in the electrolyte solution. The active layer includes a carbon structure layer and a metallic layer attached to the carbon structure layer. The carbon structure layer is deposited on the current collector.

One aspect of the present disclosure provides a method of manufacturing a capacitor. The method includes: providing a first current collector and a second current collector; forming an active layer on at least one of the first current collector and the second current collector; disposing a separating film between the first current collector and the second current collector; and immersing the separating film and the active layer on the at least one of the first current collector and the second current collector into an electrolyte solution. Forming the active layer includes: depositing a carbon structure layer on the at least one of the first current collector and the second current collector; and forming a metallic layer attached to the carbon structure layer on the at least one of the first current collector and the second current collector.

One aspect of the present disclosure provides an electrode module of an electrostatic double-layer capacitor. The electrode module includes a current collector and an active layer. The active layer includes a carbon structure layer and a metallic layer. The carbon structure layer is deposited on the current collector. The metallic layer is attached to the carbon structure layer. The metallic layer includes metallic nanoparticles, metallic nanofibers, or a combination thereof.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A capacitor, comprising:
a first electrode module;
a second electrode module, wherein at least one of the first electrode module and the second electrode module comprises a current collector and an active layer;
an electrolyte solution, wherein the active layer is immersed in the electrolyte solution; and
a separating film, disposed between the first electrode module and the second electrode module, and immersed in the electrolyte solution,
wherein the active layer comprises a carbon structure layer and a metallic layer attached to the carbon structure layer, wherein the carbon structure layer is deposited on the current collector.

2. The capacitor of claim 1, wherein the metallic layer comprises titanium nitride (TiN) nanoparticles, TiN nanofibers, or a combination thereof.

3. The capacitor of claim 1, wherein the carbon structure layer comprises carbon nanotubes, graphene, or a combination thereof.

4. The capacitor of claim 1, wherein the carbon structure layer are doped with nitrogen, wherein a ratio of nitrogen atoms to all atoms of the carbon structure layer is within a range from 3% to 10%.

5. The capacitor of claim 1, wherein the current collector comprises a metal silicide layer formed on a surface of the current collector, and the carbon structure layer is deposited on the metal silicide layer.

6. The capacitor of claim 5, wherein the metal silicide layer comprises a titanium silicide layer.

7. The capacitor of claim 1, wherein the active layer is free from being bounded by polymer binders onto the current collector.
